(19) United States
(12) Patent Application Publication
(10) Pub. No.: US 2013/0270409 A1
(43) Pub. Date: Oct. 17, 2013

(54) Portable Restraint Device

(71) Applicant: David Osorio, Bronx, NY (US)

(72) Inventor: David Osorio, Bronx, NY (US)

(21) Appl. No.: 13/445,850

(22) Filed: Apr. 12, 2012

(51) Int. Cl. B65G 7/12

(52) U.S. Cl. 248/340

(57) ABSTRACT

A portable restraint device for a commuter to retain balance on a public transportation vehicle. The portable restraint device wraps a hook around a horizontal, vertical, or ring-shaped grab bar on the train or bus. The hook may be shaped like a hook, or operable as a carbiner, and is configured to adjust and securely attach to a variety of grab bars on public transportation vehicles. The opposite end of the portable restraint device includes a loop, configured for a hand to grip. The loop is often a flexible meshing material designed for comfort on long commutes. By gripping the loop, the commuter avoids contact with the grab bar surface, thereby avoiding germs. A handle secures the hook to the loop. However, the commuter is also able to grip the handle to retain balance. After the commute finishes, the commuter disengages the portable restraint device from the grab bar.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to restraints. More particularly, one or more embodiments of the invention relate to restraints in a vehicle.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, mass transit vehicles include seats and grab bars for riders usage. Typically, if a rider cannot find a seat, the rider may stand in an aisle and support him or herself by holding a grab bar with one or both hands. These grab bars may be slippery and sometimes do not provide a safe surface for rider to hold. Additionally, the grab bars are typically used by many people, and may transfer germs to and from different riders.

Straps and handles are typically attached to bags and backpacks. Often these straps are used to transport bags and backpacks. However, straps are not typically used to assist in creating a safe surface to hold on a mass transit vehicle. Nor are straps typically used to avoid the spread of germs.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a side view of an exemplary portable restraint device, including a handle and a loop in accordance with the present invention;

FIG. 2 is a side view of a loop and handle of an exemplary restraint in accordance with an embodiment of the present invention;

FIG. 2A is an exemplary side view of the loop;

FIG. 2B is an exemplary perspective view of the hook;

FIG. 2C is an exemplary view of the handle;

FIG. 3 is an exemplary view of the fasteners; and

FIG. 4 is an exemplary view of the portable restraint device with a hand grasping the loop in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A practical embodiment of the present invention provides a portable restraint device 100 for a commuter to retain balance on a public transportation vehicle. The portable restraint device secures a hook 105 around, but not limited to, a horizontal, vertical, or ring-shaped rod or grab bar on a public transportation vehicle. In an alternative embodiment, the hook may be shaped like a hook, or operable as a carbiner, and is configured to adjust and securely attach to a variety of rods on public transportation vehicles. The opposite end of the portable restraint device may include a loop, configured for at least one hand to grip. The loop may be fabricated from a flexible meshing material designed for comfort of the commuter on long commutes. By gripping the loop, the commuter avoids contact with the surface of the rod, thereby avoiding germs. In one embodiment, a handle securely joins the hook to the loop. However, the commuter may also grip the handle rather than the loop to retain balance. After the commute finishes, the commuter disengages the portable restraint device from the rod.

In some embodiments, the portable restraint device may attach to a rod, or grab bar in the public transportation vehicle. In some embodiments, a commuter may grasp the handle of the restraint. In other embodiments, the commuter may grasp the loop of the restraint. The restraint may assist the commuter in supporting him or herself. The restraint may also assist the commuter in avoiding the spread of germs. In some embodiments the handle may be a post. In other embodiments, the handle may be one or more laces. In some embodiments, the handle may include a hook. In many practical embodiments, the hook may connect to a grab bar.

Portable restraint device 100 includes a hook 105, a handle 110 and the loop 115. Hook has a first surface and a second surface. The first surface engages a rod, including but not limited to a horizontal grab bar on the public transportation vehicle. Therefore, first surface is efficacious in securely engaging the rod so that the commuter may balance on the moving public transportation vehicle. This secure engagement between the hook and the rod is achieved in one approach by applying an adhesive to first surface to prevent slippage.

In an alternative embodiment, suitable materials for the hook may include, but are not limited to, rubber, plastic, and tape. Further embodiments of suitable material for hook include, but are not limited to: Neoprene Rubber, which has the physical characteristics of good weatherability and resistance to abrasion; Buna-N Rubber, which resists oil and solvents. Not as weather resistant. Also called nitrile, acrylonitrile, and NBR. Silicone Rubber—Good flexibility and resistance to ozone, sunlight, and oxidation. Very good electrical insulator. Also called polysiloxane. EPDM Rubber—Excellent for outdoor use. Natural Gum Rubber—Superior resilience, tensile strength, elasticity, and abrasion resistance. Viton Rubber—Resists corrosive environments, with exceptional resistance to heat, aging, weather, ozone, oxygen, and sunlight, plus fuels, solvents, and chemicals. Good flame resistance. Also called FKM. Natural Latex Rubber—Ultra-elastic has excellent strength and stretchability. Has exceptional tear resistance. SBR Rubber—Has good abrasion and wear resistance. Also called styrene butadiene. Vinyl Rubber—Good resistance to water, chemicals, and weathering. Also called polyvinyl chloride (PVC). Santoprene Rubber—Combines the characteristics of rubber and plastic to produce a material that offers excellent weatherability and chemical resistance. ECH Rubber—Excellent resistance to fuel, oil, and ozone. Also called epichlorohydrin. Butyl Rubber—Nearly air and gas tight. Has good weatherability, oxidation resistance, and electrical resistance. Excellent resistance to alkalies and acids. Often used for inner tubes. Also called isobutylene isoprene. Latex-Free TPE Rubber—Transparent elastomer with gel-like consistency to absorb vibration and conform to irregular surfaces. Super stretchy. Has great tensile strength. This type of rubber is nontoxic and nonallergenic. Hypalon Rubber—Superior weatherability and resistance to ozone, chemicals, and oil even at high temperatures. Resists flex cracking and abrasion from weather, heat, and chemical exposure. Low water absorption. Also called chlorosulfonated polyethylene.

Suitable materials for the second surface of hook may include, but are not limited to, rubber, plastic, metal, and tape. Since second surface may engage at least one hand 260. In some embodiments, second surface may comprise of cotton, nylon, polyester, or rubber. The commuter may also avoid contacting the grab bar surface by utilizing the loop. In one embodiment, the loop provides the commuter with a comfortable grip that is efficacious for retaining balance on a moving public transportation vehicle. The loop may include a variety of dimensions and shapes. A loop first dimension includes, but is not limited to eight inches. A loop second dimension includes, but is not limited to one inch. However, further embodiments may include sizes greater than eight inches, less than one inch, or between one inch and eight inches. The loop may also be oval, square, annular, or any other shape useful for a commuter to grab.

In a further embodiment, a 110 handle secures the hook to the loop. The handle may also be fastened around the loop with at least one fastener. In a further embodiment, the commuter may grab the handle or the loop. The handle may contain many dimensions and shapes. The handle may also be oval, square, annular, or any other shape useful for a commuter to grab.

Handle joins hook to loop. In some embodiments, the handle may be attached to the loop with one or more fasteners. Suitable fasteners may include, but are not limited to, pop-rivets, bolts, nuts, screws, adhesives, and clamps. Fastener's relative fastening ability may be achieved in one approach by making the fasteners from sturdy materials including, but not limited to, aluminum, plastic, and steel.

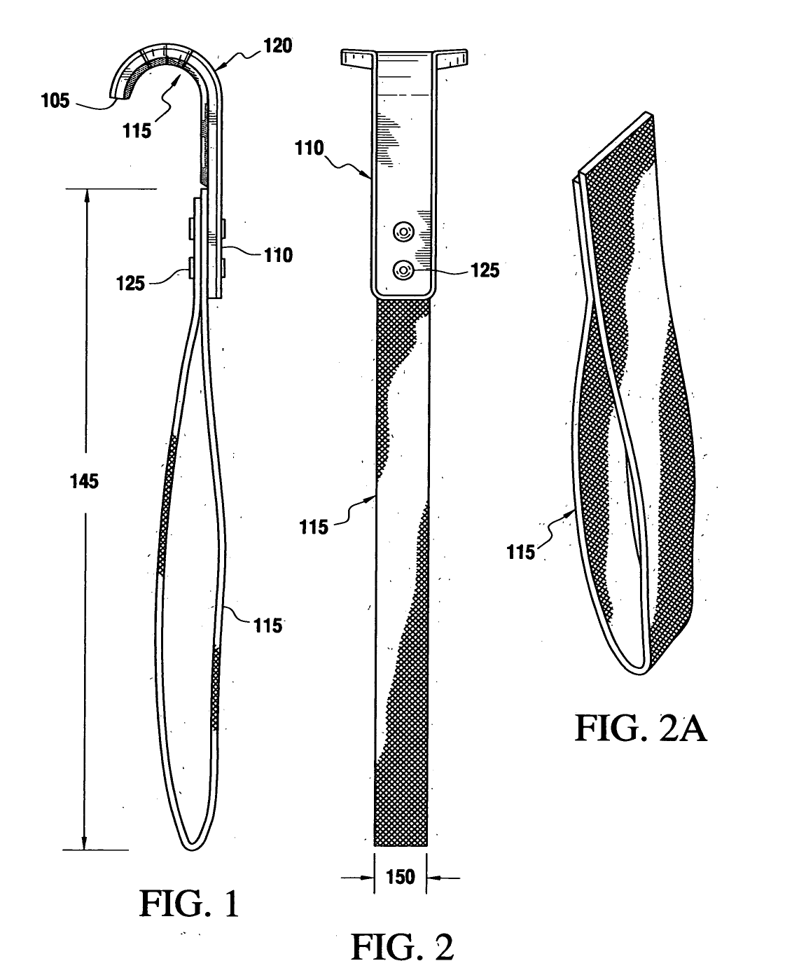

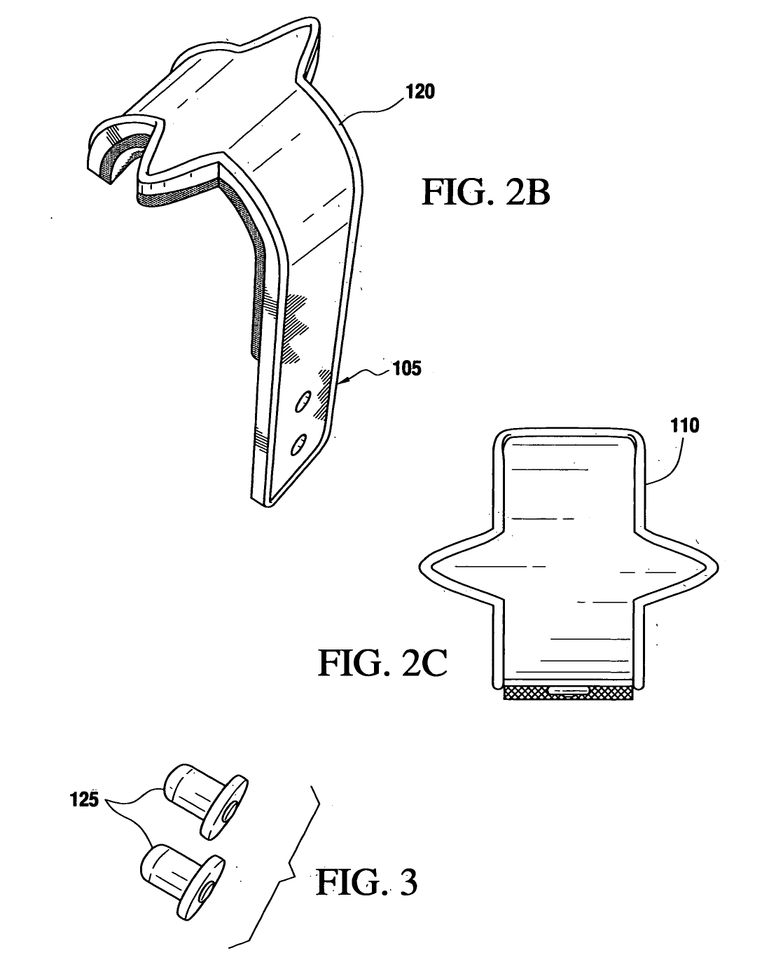

Referring initially to FIG. 1, an exemplary embodiment of a restraint is illustrated. The restraint includes a hook 105. The restraint also may include a handle 110 and a loop 115. Referring to FIGS. 2 and 2A, views of an exemplary loop are illustrated. In some embodiments, the handle 105 is attached to the loop 115 with at least one fastener 125. Suitable fasteners may include, but are not limited to, pop-rivets, bolts, nuts, screws, adhesives, and clamps (See FIG. 3). In some practical embodiments, the handle 110 and the loop 115 are removably attached with a fastener 125.

In some embodiments, the handle may have a first dimension 130 (See FIG. 2C). In the present embodiment, the first dimension of the handle may be about 3 inches. In other embodiments the handle may have a second dimension 135. In the present embodiment, the second dimension of the handle may be about 2 inches. The handle may also include a first surface 115. Suitable materials for the first surface may include, but are not limited to, rubber, plastic, and tape. In some embodiments the handle may also include a second surface 120. Suitable materials for the second surface may include, but are not limited to, rubber, plastic, and tape. In some embodiments, the handle may include a hook 140. In many practical embodiments, the hook 140 may be, but not limited to, a carbiner, a hook shape, or a grasping arm.

In some embodiments, the hook may include a first dimension 145 (See FIG. 2B). In the present embodiment, the first dimension of the hook may be about 1inch. In other embodiments, the hook may include a second dimension 150. In the present embodiment, the second dimension of the hook may be about 0.5 inches. In some embodiments the handle may include an antibacterial material. Suitable antibacterial materials may include, but are not limited to, a disinfectant, an antiseptic, and an antimicrobial. In many practical embodiments, the hook is configured to attach to a grab bar.

In some embodiments, the restraint may include a loop. Suitable materials for the loop may include, but are not limited to, a plastic, and a polymer. In some embodiments, the loop may be a mesh or a webbing. In other embodiments the loop may include an antibacterial material. Suitable antibacterial materials may include, but are not limited to, a disinfectant, an antiseptic, and an antimicrobial.

In some embodiments, the loop may have a loop first dimension 145. In the present embodiment, the first dimension of the loop may be about 8 inches. In other embodiments, the loop may have a loop second dimension 150. In the present embodiment, the second dimension of the loop may be about 1 inch.

In some embodiments, the loop 110 may be configured to attach to an object, including but not limited to, a belt or a backpack. In some embodiments, the restraint may include a closing mechanism. The closing mechanism may be used to shorten or lengthen the first dimension 145 of the loop 110. Suitable closing mechanisms may include, but are not limited to, a clamp, a carbiner, and a band.

FIG. 2 illustrates an exemplary restraint in accordance with an embodiment of the present invention. The restraint includes a handle 205. In many practical embodiments, the restraint also includes a loop 210. In some embodiments, the handle 205 in the loop 210 are attached with a fastener 225.

In some embodiments of the present invention, the handle 205 of the restraint removably connects to a grab bar 255. In some embodiments, the grab bar may be in a mass transit vehicle. Suitable grab bars may include, but are not limited to, metal bars. In some embodiments, a user may grasp the loop 210 with one or both hands 260. In other embodiments, the user may grasp the handle 205 with one or both hands 260. In some embodiments, the user may spray or apply an antibacterial material on the handle 205. In many practical embodiments, the handle 205 may be configured to avoid slippage when connected to the grab bar 255.

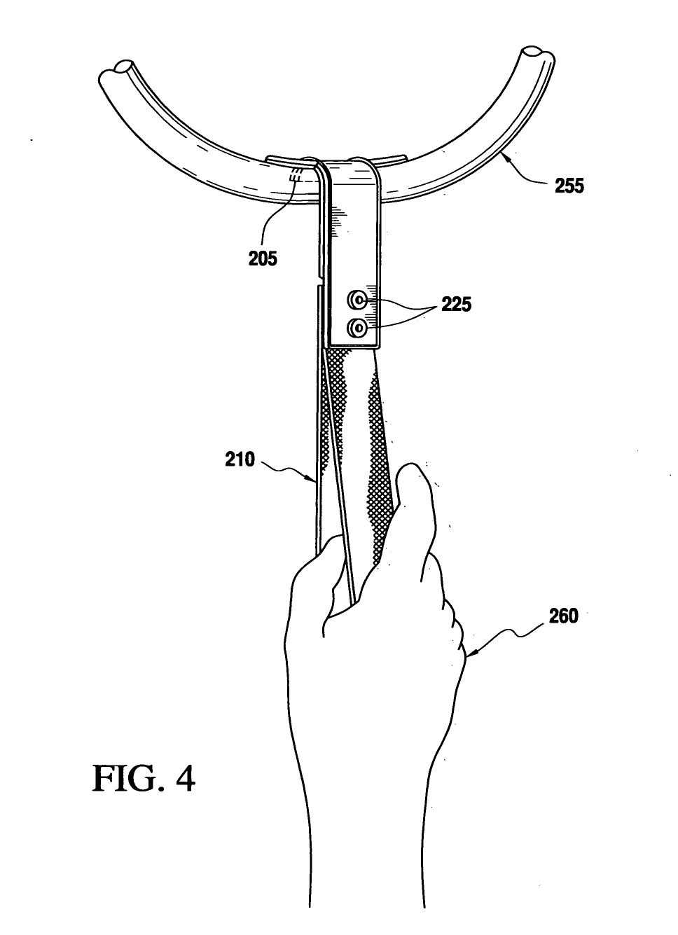

In operation, the commuter may securely attach the portable restraint device to the rod. The hook may be a carbiner in some embodiments (See FIG. 4). The hook may include a closing mechanism that forms a closed ring around the rod. The commuter may then grab the loop with one or both hands to stabilize the balance.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing a restraint according to the present invention will be apparent to those skilled in the art. The invention has been described above by way of illustration, and the specific embodiments disclosed are not intended to limit the invention to the particular forms disclosed. For example, the particular implementation of the restraint may vary depending upon the particular context or application. The restraints described in the foregoing were principally directed to physical implementations; however, similar techniques of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A portable restraint device comprising:
a hook, said hook being operable to securely engage a rod;
a handle, said handle joined with said hook;
a loop, said loop being configured to receive at least one hand; and
at least one fastener, said at least one fastener being operable to join said loop to said handle.

2. The portable restraint device of claim 1, wherein said rod comprises a grab bar on a transportation vehicle.

3. The portable restraint device of claim 2, wherein said hook comprises a first surface, said first surface being operable to engage said rod.

4. The portable restraint device of claim 3, wherein said first surface comprises a metal.

5. The portable restraint device of claim 3, wherein said first surface comprises a plastic.

6. The portable restraint device of claim 4, in which said first surface further includes an adhesive, said adhesive being operable to securely engage said rod.

7. The portable restraint device of claim 6, wherein said hook comprises a second surface.

8. The portable restraint device of claim 7, wherein said second surface comprises a plastic.

9. The portable restraint device of claim 8, wherein said hook comprises an annular member, said annular member being operable to securely join with said rod.

10. The portable restraint device of claim 9, wherein said annular member is a carbiner.

11. The portable restraint device of claim 10, wherein said hook comprises a flexible material.

12. The portable restraint device of claim 11, wherein said loop comprises a flexible webbing, said flexible webbing being disposed to receive said at least one hand.

13. The portable restraint device of claim 12, wherein said loop comprises an antibacterial material.

14. The portable restraint device of claim 13, wherein said loop comprises a closing mechanism.

15. The portable restraint device of claim 14, wherein said loop is operable to join to a carrying case.

16. The portable restraint device of claim 15, wherein said loop comprises a loop first dimension.

17. The portable restraint device of claim 16, wherein said loop comprises a loop second dimension.

18. The portable restraint device of claim 17, wherein said at least one fastener comprises at least one bolt.

19. A portable restraint device, said portable restraint device comprising:
means for at least one hand to grab a loop;
means for securely joining a hook to a rod, said hook being joined to said loop by means of a handle; and
means for stabilizing balance while standing in a transportation vehicle.

20. A portable restraint device comprising:
a hook, said hook being operable to securely engage a rod, said rod comprising a grab bar on a transportation vehicle, said hook comprising a first surface, said first surface being operable to engage said rod, said hook further comprising a second surface;
a handle, said handle joined with said hook;
a loop, said loop being configured to receive at least one hand, said loop comprising a flexible webbing; and
at least one fastener, said at least one fastener being operable to join said loop to said handle.
